(19) United States
(12) Patent Application Publication
(10) Pub. No.: US 2012/0045110 A1
(43) Pub. Date: Feb. 23, 2012

(54) METHOD OF ENCODING A RADIOGRAPHIC IMAGE SIGNAL, METHOD OF DECODING A RADIOGRAPHIC IMAGE SIGNAL, RADIOGRAPHIC IMAGE DETECTION DEVICE AND RADIOGRAPHIC IMAGE SIGNAL GENERATION DEVICE

(75) Inventors: Naoto IWAKIRI, Ashigarakami-gun (JP); Naoyuki NISHINO, Ashigarakami-gun (JP); Yasunori OHTA, Ashigarakami-gun (JP); Makoto SUGIZAKI, Ashigarakami-gun (JP); Haruyasu NAKATSUGAWA, Ashigarakami-gun (JP)

(73) Assignee: FUJIFILM CORPORATION, Tokyo (JP)

(21) Appl. No.: 13/213,728

(22) Filed: Aug. 19, 2011

(30) Foreign Application Priority Data
Aug. 20, 2010 (JP) 2010-184670

(51) Int. Cl. G06K 9/00

(52) U.S. Cl. 382/132

(57) ABSTRACT

From a radiation detecting unit for detecting a radiographic image of a subject by receiving radiation transmitted through the subject, a radiographic image signal representing the radiographic image is read out, and information about an imaging operation carried out to obtain the radiographic image of the subject is obtained. The radiographic image signal is encoded with using key information based on the obtained information about the imaging operation to generate an encoded radiographic image signal, and the encoded radiographic image signal is outputted as a radio communication signal.

### BACKGROUND OF THE INVENTION

1. Field of the Invention

The present invention relates to a method of encoding a radiographic image signal, which encodes a radiographic image signal read from a radiation detecting unit for detecting a radiographic image of a subject by receiving radiation transmitted through the subject and transmits the encoded radiographic image signal as a radio communication signal, a method of decoding the encoded radiographic image signal to generate a radiographic image signal, a radiographic image detection device using the method of encoding, and a radiographic image signal generation device using the method of decoding.

2. Description of the Related Art

Conventionally, in the medical field, etc., various types of radiation detectors for recording a radiographic image of a subject by receiving radiation transmitted through the subject have been proposed and reduced into practice.

Such radiation detectors include, for example, those employing a semiconductor, such as amorphous selenium, which generates an electric charge when exposed to radiation. As this type of radiation detectors, those of the so-called optical reading system and of the TFT reading system have been proposed.

As a radiographic imaging system employing the above-described type of radiation detector, Japanese Unexamined Patent Publication No. 2003-210444 (hereinafter, Patent Document 1) proposes a system including a radiographic image detection device for outputting a radiographic image signal, which is read from a radiation detector, as a radio communication signal, and a control device for receiving the radio communication signal from the radiographic image detection device and outputting a control signal to the radiographic image detection device as a radio communication signal.

A radiographic image obtained by imaging a patient, who is the subject, contains private information of the patient, such as a lesion in the body. Therefore, it is necessary to increase information security to prevent radiographic image signals containing such private information of patients from being intercepted by a third person or leaking during radio communication.

As a method for protecting such private information of patients, Japanese Unexamined Patent Publication No. 2010-012060 (hereinafter, Patent Document 2), for example, proposes a method which involves decimating a radiographic image signal to generate a low-resolution radiographic image signal, thereby making it difficult to identify the personal information even if the signal is intercepted.

The method disclosed in Patent Document 2, however, does not provide sufficient protection since fracture or deformation of bone is recognizable even with a low-resolution radiographic image signal.

Further, Japanese Unexamined Patent Publication No. 2002-094914 (hereinafter, Patent Document 3) proposes a method of installing a device which outputs a radiographic image signal as a radio communication signal and a device which receives the radio communication signal outputted from the former device in an imaging room provided with a radio shield to prevent leakage of radio waves.

The method disclosed in Patent Document 3, however, requires providing a radio-shielded imaging room and providing wired connection between a receiving unit in the imaging room and a control device disposed outside the imaging room. Therefore, it is troublesome and costly to provide cables, etc.

Japanese Domestic Re-publication of PCT International Application No. 2006-101230 (hereinafter, Patent Document 4) proposes a method which involves encoding a radiographic image signal when the radiographic image signal is outputted as a radio communication signal, and decoding the encoded signal at a receiving unit to generate a radiographic image signal.

As a method used to encode a radiographic image signal, a commonly known method is to encode a signal using key information. However, in the case where such a method is used, if the key information itself has leaked, the radiographic image signals can be decoded by a third person. Therefore, there still remains a security problem.

### SUMMARY OF THE INVENTION

In view of the above-described circumstances, the present invention is directed to providing a method of encoding a radiographic image signal, a method of decoding a radiographic image signal, a radiographic image detection device and a radiographic image signal generation device, where it is made difficult for a third person to obtain key information, and even if the key information has leaked, new key information is immediately generated to make decoding by a third person difficult.

An aspect of the method of encoding a radiographic image signal of the invention is a method of encoding a radiographic image signal including: reading, from a radiation detecting unit for detecting a radiographic image of a subject by receiving radiation transmitted through the subject, a radiographic image signal representing the radiographic image and obtaining information about an imaging operation carried out to obtain the radiographic image of the subject; generating an encoded radiographic image signal by encoding the radiographic image signal with using key information based on the obtained information about the imaging operation; and outputting the encoded radiographic image signal as a radio communication signal.

An aspect of the method of decoding a radiographic image signal of the invention is a method of decoding a radiographic image signal including: receiving an input of information about an imaging operation carried out to obtain a radiographic image of a subject; outputting, to a radiographic image detection device for detecting a radiographic image signal of the subject by receiving radiation transmitted through the subject, the received information about the imaging operation as a radio communication signal; receiving an encoded radiographic image signal outputted as a radio communication signal from the radiographic image detection device, the encoded radiographic image signal being generated at the radiographic image detection device by encoding the radiographic image signal with using key information based on the information about the imaging operation; and generating a radiographic image signal by decoding the received encoded radiographic image signal with using key information based on the information about the imaging operation.

An aspect of the radiographic image detection device of the invention is a radiographic image detection device including: a radiation detecting unit for detecting a radiographic image of a subject by receiving radiation transmitted through the subject; a reading unit for reading a radiographic image signal representing the radiographic image from the radiation detecting unit; an imaging information obtaining unit for obtaining information about an imaging operation carried out to obtain the radiographic image of the subject; an encoding unit for generating an encoded radiographic image signal by encoding the radiographic image with using key information based on the information about the imaging operation obtained by the imaging information obtaining unit; and a radio communication unit for outputting the encoded radiographic image signal generated by the encoding unit as a radio communication signal.

In the radiographic image detection device of the invention, the information about the imaging operation may include information that varies for each imaging operation carried out to obtain the radiographic image.

The key information may be generated with using a part of the information about the imaging operation.

The information about the imaging operation may include at least one of an imaging procedure for obtaining the radiographic image, patient information of a patient who is the subject, and an imaging time of the radiographic image.

The information about the imaging operation may include imaging conditions obtained during the imaging operation carried out to obtain the radiographic image.

An aspect of the radiographic image signal generation device of the invention is a radiographic image signal generation device including: an imaging information receiving unit for receiving an input of information about an imaging operation carried out to obtain a radiographic image of a subject; a radio communication unit for outputting the information about the imaging operation received by the imaging information receiving unit as a radio communication signal to the above-described radiographic image detection device of the invention, and for receiving an encoded radiographic image signal generated at the radiographic image detection device with using key information based on the information about the imaging operation and outputted as a radio communication signal; and a decoding unit for generating a radiographic image signal by decoding the encoded radiographic image signal received by the radio communication unit with using key information based on the information about the imaging operation.

In the radiographic image signal generation device of the invention, the information about the imaging operation may include information that varies for each imaging operation carried out to obtain the radiographic image.

The key information maybe generated with using apart of the information about the imaging operation.

The information about the imaging operation may include at least one of an imaging procedure for obtaining the radiographic image, patient information of a patient who is the subject, and an imaging time of the radiographic image.

The information about the imaging operation may include imaging conditions obtained during the imaging operation carried out to obtain the radiographic image.

According to the method of encoding a radiographic image signal, the method of decoding a radiographic image signal, the radiographic image detection device and the radiographic image signal generation device of the invention, a radiographic image signal representing a radiographic image of a subject is read from a radiation detecting unit for detecting the radiographic image of the subject by receiving radiation transmitted through the subject, and information about an imaging operation carried out to obtain the radiographic image of the subject is obtained. Then, an encoded radiographic image signal is generated by encoding the radiographic image signal with using key information based on the obtained information about the imaging operation, and the encoded radiographic image signal is outputted as a radio communication signal. Then, the outputted encoded radiographic image signal is received, and a radiographic image signal is generated by decoding the received encoded radiographic image signal with using key information based on the information about the imaging operation. In the invention, information which is in general recognized only as information about an imaging operation is used as the key information. Therefore, it is made difficult for a third person to obtain the key information. Further, the information about the imaging operation varies for each imaging operation carried out to obtain a radiographic image. Therefore, new key information is immediately generated, and this makes decoding by a third person difficult.

In addition, the key information is generated using the information about the imaging operation. This facilitates parallel use of an existing device which does not perform encoding of radiographic image signals.

### BRIEF DESCRIPTION OF THE DRAWINGS

FIG. 1 is a diagram illustrating the schematic configuration of a radiographic imaging system which uses one embodiment of a radiographic image detection device and a radiographic image signal generation device of the present invention,

FIG. 2 is a diagram illustrating the internal structure of a radiation detecting cassette,

FIG. 3 is a block diagram illustrating the schematic configuration of the radiographic imaging system,

FIG. 4 is a block diagram illustrating apart of the internal structure of a cassette transceiver and a console transceiver, and

FIG. 5 is a diagram for explaining operation of the radiographic imaging system which uses one embodiment of the radiographic image detection device and the radiographic image signal generation device of the invention.

### DESCRIPTION OF THE PREFERRED EMBODIMENTS

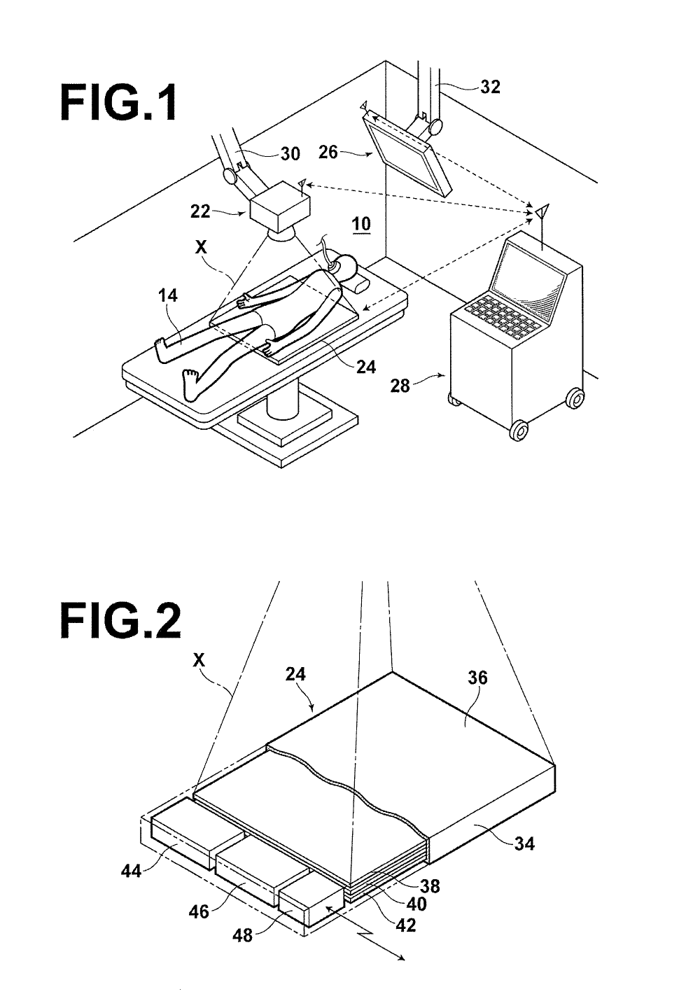

Hereinafter, a radiographic imaging system which uses one embodiment a radiographic image detection device and a radiographic image signal generation device of the present invention will be described with reference to the drawings. FIG. 1 shows the appearance of an operating room, in which a radiographic imaging system 10 of this embodiment is installed.

The radiographic imaging system 10 of this embodiment includes: an imaging unit 22 for applying, to a patient, radiation X of a dose according to imaging conditions; a radiation detecting cassette 24 containing a radiation detector for detecting the radiation X transmitted through the patient 14 and recording a radiographic image of the patient 14; a display unit 26 for displaying the radiographic image detected by the radiation detector; and a console 28 for controlling the imaging unit 22, the radiation detecting cassette 24 and the display unit 26. Signals are communicated among the console 28, the imaging unit 22, the radiation detecting cassette 24 and the display unit 26 via radio communication.

The imaging unit 22 is coupled to a universal arm 30 so that the imaging unit 22 is movable to a desired position depending on a part to be imaged of the patient 14 and retractable to a position where it does not hinder an operation conducted by a physician. Similarly, the display unit 26 is coupled to a universal arm 32 so that the display unit 26 is movable to a position where the physician can easily observe an obtained radiographic image.

FIG. 2 is a diagram illustrating the internal structure of the radiation detecting cassette 24. The radiation detecting cassette 24 includes a casing 34 made of a material that transmits the radiation X. The casing 34 contains therein: a grid 38 for removing scattered rays of the radiation X scattered by the patient 14; a radiation detector 40 for detecting the radiation X transmitted through the patient 14 and recording a radiographic image of the patient 14; and a lead plate 42 for absorbing backscatter of the radiation X, which are disposed in this order from an exposed surface 36 of the casing 34, on which the radiation X is applied.

The casing 34 further contains therein: a battery 44 serving as a power supply to the radiation detecting cassette 24; a cassette control unit 46 for controlling driving of the radiation detector 40 with the electric power supplied from the battery 44; and a cassette transceiver 48 for transmitting a radiographic image signal read from the radiation detector 40, etc., to the console 28 as a radio communication signal, and receiving a control signal, etc., outputted from the console 28.

The cassette control unit 46 and the cassette transceiver 48 may be provided with a lead plate, or the like, on the side nearer to the exposed surface 36 of the casing 34 to avoid damage due to exposure to the radiation X.

The radiation detector 40 is of a type that is repeatedly usable to record and read a radiographic image. The radiation detector 40 may be a so-called direct-type radiographic image detector, which directly receives the radiation and generates an electric charge, or may be a so-called indirect-type radiographic image detector, which once converts the radiation into visible light, and then, converts the visible light into an electric charge signal. As the reading system to read out the radiographic image signal, a so-called TFT reading system that reads out the radiographic image signal with turning on and off TFT (thin film transistor) switches, or a so-called optical reading system that reads out the radiographic image signal by applying reading light may be used; however, this is not intended to limit the invention, and any other system may be used.

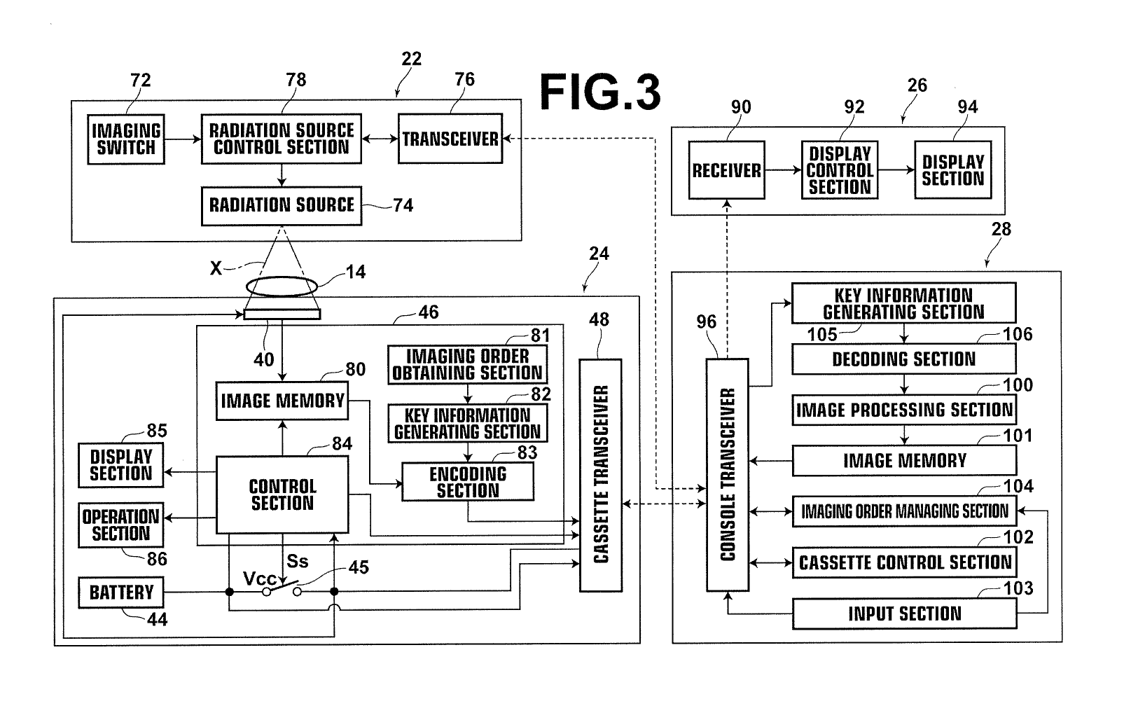

FIG. 3 is a block diagram illustrating the internal structure of the radiographic imaging system 10 including the imaging unit 22, the radiation detecting cassette 24, the display unit 26 and the console 28.

The imaging unit 22 includes: an imaging switch 72; a radiation source 74 for emitting the radiation X; a transceiver 76 for receiving imaging conditions from the console 28 via radio communication and transmitting an imaging completion signal, etc., to the console 28 via radio communication; and a radiation source control section 78 for controlling the radiation source 74 based on an imaging start signal fed from the imaging switch 72 and the imaging conditions fed from the transceiver 76.

As described above, the radiation detecting cassette 24 contains the radiation detector 40, the battery 44, the cassette control unit 46, the cassette transceiver 48 and the power supply switch 45. The radiation detecting cassette 24 further includes a display section 85 for displaying imaging order information outputted from the console 28, an operation section 86 that is used to input signals for operating the radiation detecting cassette 24, etc.

The cassette control unit 46 includes: an image memory 80 for storing the radiographic image signal read from the radiation detector 40; an imaging order obtaining section 81 for obtaining the imaging order information outputted from the console 28 and received by the cassette transceiver 48; a key information generating section 82 for generating key information based on the imaging order obtained by the imaging order obtaining section 81; an encoding section 83 for encoding the radiographic image signal read from the image memory 80 based on the key information generated at the key information generating section 82; and a control section 84 for controlling the units described above.

The imaging order obtaining section 81 obtains the imaging order information outputted from the console 28, as described above. Now, the imaging order information is described.

The imaging order information is set by a physician or radiation technologist (who will hereinafter be referred to as “operator”) via the input section 103 of the console 28 before an imaging operation to obtain a radiographic image is carried out. The imaging order information may include, for example, an imaging procedure, an imaging time and patient information. Settings of these information items are registered at the console 28 for each radiographic imaging operation, and the contents thereof vary for each imaging operation.

The information of imaging procedure may be displayed on the display section 85 of the radiation detecting cassette 24 and used for positioning of the patient 14 by the operator, for example. The information of imaging procedure may also be used for determining the tube voltage, the tube current, the exposure time, etc., for applying an appropriate dose of the radiation X to the patient 14.

Setting of the imaging time may be inputted by the operator, as described above, or a time indicated by a timer (not shown) provided in the console 28 may automatically be obtained as the imaging time when the imaging order information is outputted from the console 28.

The patient information is information to identify the patient 14, such as the name, sex and patient ID number of the patient 14.

It should be noted that, although the imaging procedure, the imaging time and the patient information are described as the imaging order information in this embodiment, the imaging order information may include any other order information. In particular, the imaging order information may further include information that varies for each radiographic imaging operation.

The key information generating section 82 receives the imaging order information obtained by the imaging order obtaining section 81 and generates key information used for encoding based on the imaging order information. In this embodiment, specifically, the key information generating section 82 extracts digital data which represents a partial character string, such as the first eight characters or the 9th to the 15th characters, of a character string (which also includes numeric characters) forming the imaging order information to generate the key information. It should be noted that, although the partial character string of the imaging order information is used as the key information in this embodiment, the entire character string of the imaging order information may be used as the key information.

The encoding section 83 receives the key information generated at the key information generating section 82, as described above, and uses the key information to encode the radiographic image signal read from the image memory 80. As the encoding method, RC4, DES (Data Encryption Standard), IDEA (International Data Encryption Algorithm), FEAL (First Encryption Algorithm), MISTY, WEP (Wired Equivalent Privacy) or AES (Advanced Encryption Standard), may be used, for example. Any other encoding method may be used.

Further, the encoding section 83 obtains the imaging order information obtained at the imaging order obtaining section 81, and adds the imaging order information as header information to the encoded radiographic image signal to output the encoded radiographic image signal.

The control section 84 controls reading of the radiographic image signal from the radiation detector 40 and the image memory 80. Further, the control section 84 outputs various information in the radiation detecting cassette 24, such as an operating status of the radiation detector 40, to the console 28 via the cassette transceiver 48, and receives various control signals directed to the radiation detecting cassette 24 from the console 28 via the cassette transceiver 48.

The power supply switch 45 is turned on or off according to a control signal Ss fed from the control section 84 of the cassette control unit 46 to connect the battery 44 with the radiation detector 40, the cassette control unit 46, the cassette transceiver 48, etc. The control section 84 feeds the control signal Ss to the power supply switch 45 based on the control signal outputted from the console 28 and received via the cassette transceiver 48.

The display unit 26 includes: a receiver 90 for receiving a radiographic image signal from the console 28; a display control section 92 for controlling display of the received radiographic image signal; and a display section 94 for displaying the radiographic image based on the radiographic image signal processed by the display control section 92.

The console 28 includes: a console transceiver 96 for transmitting and receiving necessary information, including the radiographic image signal, to and from the imaging unit 22, the radiation detecting cassette 24 and the display unit 26 via radio communication; an imaging order managing section 104 for managing the above-described imaging order information; a key information generating section 105 for generating key information based on the imaging order information outputted together with the encoded radiographic image signal from the radiation detecting cassette 24; a decoding section 106 for decoding the encoded radiographic image signal outputted from the radiation detecting cassette 24 with using the key information generated by the key information generating section 105 to generate a radiographic image signal; an image processing section 100 for applying image processing to the decoded radiographic image signal; an image memory 101 for storing the radiographic image signal subjected to the image processing; a cassette control section 102 for outputting a control signal to turn on the power supply switch 45 of the radiation detecting cassette 24 and various control signals and receiving various information in the radiation detecting cassette 24, such as an operating status of the radiation detector 40, from the radiation detecting cassette 24; and an input section 103 for receiving inputs of the imaging procedure and the patient information of the patient to be imaged.

Although the imaging order managing section 104 obtains the imaging order information by receiving the imaging order information inputted by the operator via the input section 103 in this embodiment, the imaging order managing section 104 may obtain the imaging order information fed from an external device via a network, in place of an input via the input section 103.

The key information generating section 105 obtains the imaging order information added as the header information to the encoded radiographic image signal outputted from the radiation detecting cassette 24, and generates the key information used for decoding based on the imaging order information. As the method for generating the key information, the same method as that used at the key information generating section 82 of the radiation detecting cassette 24 is used. Although the key information is generated based on the imaging order information outputted as the header information from the radiation detecting cassette 24 in this embodiment, this is not intended to limit the invention. The key information may be generated using the imaging order information received at the imaging order managing section 104.

As described above, the decoding section 106 decodes the encoded radiographic image signal outputted from the radiation detecting cassette 24 with using the key information generated at the key information generating section 105. The decoding is achieved with using processing according to the encoding method used at the encoding section 83 of the radiation detecting cassette 24.

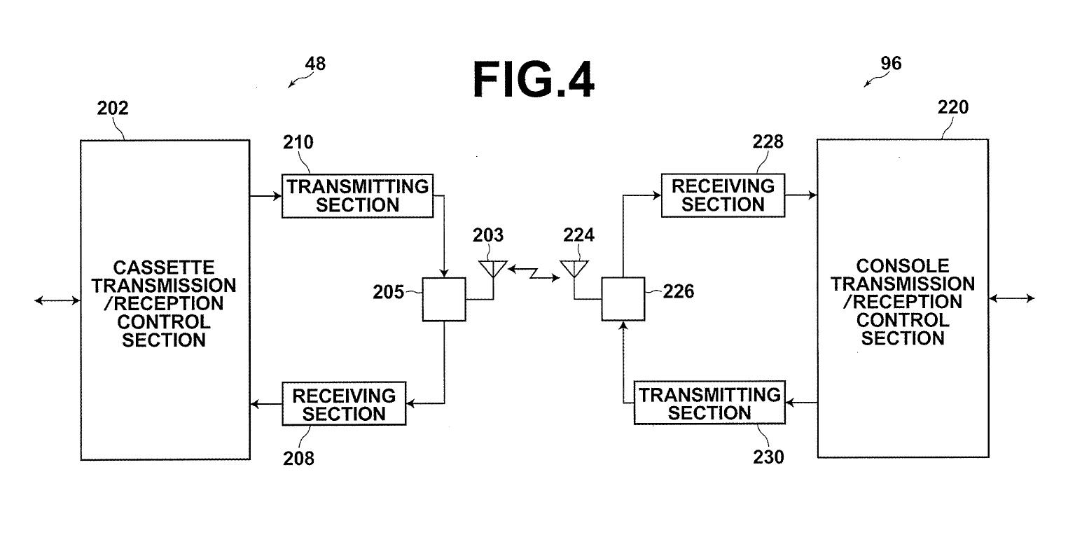

FIG. 4 is a block diagram illustrating apart of the internal structure of the cassette transceiver 48 in the radiation detecting cassette 24 and the console transceiver 96 in the console 28.

The cassette transceiver 48 in the radiation detecting cassette 24 includes a cassette transmission/reception control section 202 including a microcomputer, an antenna 203, an antenna duplexer 205, a receiving section 208 and a transmitting section 210.

The receiving section 208 receives a radio wave received by the antenna 203 via the antenna duplexer 205 and demodulates and outputs the radio wave as a received signal to the cassette transmission/reception control section 202. The transmitting section 210 modulates and outputs the encoded radiographic image signal with the header information (imaging order information) added thereto, which has been outputted from the encoding section 83 and then outputted from the cassette transmission/reception control section 202 at a predetermined transmission rate.

On the other hand, the console transceiver 96 includes a console transmission/reception control section 220 including a microcomputer, an antenna 224, an antenna duplexer 226, a receiving section 228 and a transmitting section 230.

The receiving section 228 receives a radio wave received by the antenna 224 via the antenna duplexer 226 and demodulates and outputs the radio wave as received data to the console transmission/reception control section 220. The transmitting section 210 modulates and outputs the imaging order information, etc., which has been outputted from the imaging order managing section 104 and then outputted from the console transmission/reception control section 220 at a predetermined transmission rate.

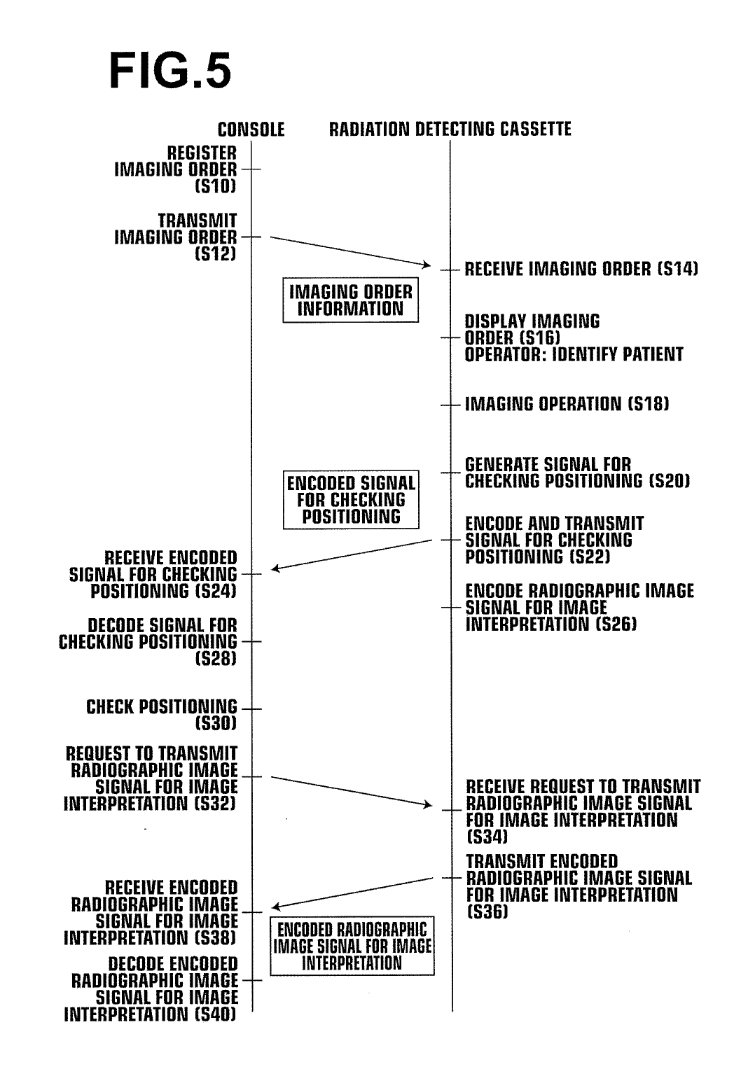

Next, operations of the radiographic imaging system 10 of this embodiment are described with reference to FIG. 5. FIG. 5 shows the operations carried out at the console 28 and at the radiation detecting cassette 24 in time series from the top to the bottom.

First, the operator registers settings of the imaging order information, such as the patient information of the patient to be imaged and the imaging procedure, via the input section 103 of the console 28 (S10). Then, the imaging order information inputted via the input section 103 is obtained and stored by the imaging order managing section 104.

Then, when the operator has made a predetermined operation, the control signal to turn on the power supply switch 45 of the radiation detecting cassette 24 is outputted from the cassette control section 102 of the console 28, and the control signal is outputted from the console transceiver 96 of the console 28.

Then, the control signal is received by the cassette transceiver 48 of the radiation detecting cassette 24 and is fed to the control section 84, and then, is fed from the control section 84 to the power supply switch 45 to turn on the power supply switch 45.

After the power supply to the radiation detecting cassette 24 is turned on as described above, the imaging order information is read out from the imaging order managing section 104 and is outputted from the console 28 via the console transceiver 96 (S12).

The imaging order information outputted from the console 28 is received by the cassette transceiver 48 of the radiation detecting cassette 24 and obtained by the imaging order obtaining section 81 of the cassette control unit 46 (S14).

Then, the imaging order information obtained by the imaging order obtaining section 81 is obtained by the control section 84, and the control section 84 causes the display section 85 to display the obtained imaging order information (S16).

The operator identifies the patient 14 based on the imaging order information displayed on the display section 85. Then, the operator sets the radiation detecting cassette 24 at a predetermined position between the patient 14 and an operation table 16 with the exposed surface 36 of the cassette 24 facing the imaging unit 22, and positions the patient 14 based on the content of the imaging procedure.

After the patient 14 has been positioned, as described above, an imaging operation to obtain a radiographic image is carried out (S18).

Specifically, the imaging unit 22 is moved to a position where it faces the radiation detecting cassette 24, and then, the imaging switch 72 is operated to carry out imaging.

The radiation source control section 78 of the imaging unit 22 obtains imaging conditions relating to the imaged part of the patient 14 from the imaging order managing section 104 of the console 28 via radio communication between the console transceiver 96 and the transceiver 76, and controls the radiation source 74 according to the obtained imaging conditions to apply the radiation X of a predetermined dose to the patient 14.

The radiation X transmitted through the patient 14, with the scattered rays thereof removed by the grid 38 of the radiation detecting cassette 24, is applied to the radiation detector 40, and then is subjected to photoelectric conversion at the radiation detector 40 to be stored as an electric charge signal.

After the application of the radiation X has been finished, as described above, the electric charge signal stored in the radiation detector 40 is read out by the control section 84 of the cassette control unit 46, sampled by a sample-and-hold circuit, converted into a digital signal by an A/D converter, and is once stored in the image memory 80.

When the amount of the radiographic image signal stored in the image memory 80 has reached a unit necessary for transmission, the control section 84 of the cassette control unit 46 sequentially reads out the radiographic image signal of the unit of transmission from the image memory 80 and feeds the radiographic image signal to the encoding section 83.

At this time, the control section 84 generates a decimated low-resolution radiographic image signal of the radiographic image signal stored in the image memory 80 as a signal for checking positioning, and outputs the signal for checking positioning to the encoding section 83 (S20).

On the other hand, the imaging order information obtained by the imaging order obtaining section 81 of the cassette control unit 46 is also fed to the key information generating section 82, and the key information generating section 82 generates the key information based on the imaging order information fed thereto. The method used to generate the key information is as described above.

The key information generated by the key information generating section 82 is fed to the encoding section 83, and the encoding section 83 uses the key information fed thereto to encode the signal for checking positioning to generate an encoded signal for checking positioning (S22).

The encoding section 83 adds the imaging order information as the header information to the encoded signal for checking positioning generated as described above and outputs the encoded signal for checking positioning to the cassette transceiver 48.

Then, the encoded signal for checking positioning with the imaging order information is outputted at a predetermined transmission rate by the cassette transmission/reception control section 202 in the cassette transceiver 48 to the transmitting section 210, modulated at the transmitting section 210, and then, transmitted to the console 28 via the antenna duplexer 205 and the antenna 203 as a radio communication signal (S22).

The modulated signal transmitted to the console 28 is received by the console transceiver 96 of the console 28 (S24), and is demodulated at the console transceiver 96 into the encoded signal for checking positioning with the imaging order information.

Subsequently, the encoded signal for checking positioning with the imaging order information demodulated at the console transceiver 96 is fed to the key information generating section 105, and the key information is generated at the key information generating section 105 based on the imaging order information. The method used to generate the key information is as described above.

Then, the key information generated at the key information generating section 105 and the encoded signal for checking positioning are fed to the decoding section 106, and the decoding section 106 uses the key information fed thereto to decode the encoded signal for checking positioning to generate the signal for checking positioning (S28).

The signal for checking positioning generated at the decoding section 106 is subjected to predetermined image processing at the image processing section 100, and then is once stored in the image memory 101 with being associated with the patient information of the patient 14 registered in the imaging order managing section 104.

Subsequently, the signal for checking positioning subjected to the image processing is transmitted from the console transceiver 96 to the display unit 26. Then, the display unit 26, which has received the signal for checking positioning at the receiver 90 of the display unit 26, controls the display section 94 via the display control section 92 to display an image for checking positioning on the display section 94.

Then, the image for checking positioning displayed on the display section 94 is checked by the operator (S30). If it is determined that there is no particular problem in positioning of the patient 14, the operator inputs an instruction to request a radiographic image signal for image interpretation via the input section 103.

A signal representing the instruction to request the radiographic image signal for image interpretation inputted via the input section 103 is outputted to the radiation detecting cassette 24 via the console transceiver 96 (S32), received by the cassette transceiver 48, and fed to the control section 84 (S34).

On the other hand, at the radiation detecting cassette 24, after the encoded signal for checking positioning has been transmitted and while the operator checks the image for checking positioning as described above, the control section 84 feeds the radiographic image signal before the decimation read out from the image memory 80 to the encoding section 83 as the radiographic image signal for image interpretation.

Then, the encoding section 83 uses the key information, which was used to encode the signal for checking positioning, to encode the radiographic image signal for image interpretation to generate an encoded radiographic image signal for image interpretation (S26).

Then, the control section 84 of the radiation detecting cassette 24 causes the encoding section 83 to output the encoded radiographic image signal for image interpretation in response to the signal representing the instruction to request the radiographic image signal for image interpretation outputted from the console 28. At this time, the imaging order information is again added as the header information to the encoded radiographic image signal for image interpretation to be fed to the cassette transceiver 48.

Then, the encoded radiographic image signal for image interpretation with the imaging order information is outputted at a predetermined transmission rate by the cassette transmission/reception control section 202 in the cassette transceiver 48 to the transmitting section 210, modulated at the transmitting section 210, and transmitted as a radio communication signal to the console 28 via the antenna duplexer 205 and the antenna 203 (S36).

The modulated signal transmitted to the console 28 is received by the console transceiver 96 of the console 28 (S38), and is demodulated at the console transceiver 96 into the encoded radiographic image signal for image interpretation with the imaging order information.

Subsequently, the encoded radiographic image signal for image interpretation with the imaging order information, which has been demodulated at the console transceiver 96, is fed to the key information generating section 105, and the key information generating section 105 generates the key information based on the imaging order information.

Then, the key information generated at the key information generating section 105 and the encoded radiographic image signal for image interpretation are fed to the decoding section 106, and the decoding section 106 uses the key information fed thereto to decode the encoded radiographic image signal for image interpretation to generate the radiographic image signal for image interpretation (S40).

The radiographic image signal for image interpretation generated at the decoding section 106 is subjected to predetermined image processing at the image processing section 100, and then is stored in the image memory 101 with being associated with the patient information of the patient 14 registered in the imaging order managing section 104.

Then, the radiographic image signal for image interpretation subjected to the image processing is transmitted from the console transceiver 96 to the display unit 26. Then, the receiver 90 of the display unit 26 receives the radiographic image signal for image interpretation, and the display unit 26 controls the display section 94 via the display control section 92 to display the radiographic image for image interpretation on the display section 94.

It should be noted that, although the key information is generated based on the imaging order information received at the console 28 in the above-described embodiment, this is not intended to limit the invention. For example, imaging conditions during an imaging operation carried out to obtain the radiographic image may be obtained by the radiation detecting cassette 24 or the console 28, and the key information may be generated based on the imaging conditions. The imaging conditions may include, for example, a tube voltage, a mAs value, a set SID, the number of radiographic images obtained, a radiation exposure time, etc., during the imaging operation carried out to obtain the radiographic image; however, any other condition may be used. The set SID is a distance between the radiation source 74 and the radiation detector 40 during the imaging operation carried out to obtain the radiographic image. The tube voltage, the mAs value, etc., can be obtained when AEC (Auto Exposure Control) is carried out, for example.

Then, the key information generating section 82 of the radiation detecting cassette 24 may generate the key information based on these imaging conditions to encode the signal for checking positioning and the radiographic image signal for image interpretation with using the key information. Then, the encoded signal for checking positioning and the encoded radiographic image signal for image interpretation with the imaging conditions added as the header information may be outputted from the radiation detecting cassette 24 to the console 28, so that the key information is generated at the console 28 based on the received imaging conditions and the encoded signal for checking positioning and the encoded radiographic image signal for image interpretation are decoded with using the key information to generate the signal for checking positioning and the radiographic image signal for image interpretation.

Further, although the same key information is generated at the radiation detecting cassette 24 and the console 28 to carry out the encoding and decoding with using the key information in the above-described embodiment, in the case where the console 28 does not include the key information generating section 105 or the decoding section 106, for example, the signal for checking positioning and the radiographic image signal for image interpretation which are not encoded may be outputted from the radiation detecting cassette 24. This increases compatibility with existing systems.

1. A method of encoding a radiographic image signal, the method comprising:
reading, from a radiation detecting unit for detecting a radiographic image of a subject by receiving radiation transmitted through the subject, a radiographic image signal representing the radiographic image and obtaining information about an imaging operation carried out to obtain the radiographic image of the subject;
generating an encoded radiographic image signal by encoding the radiographic image signal with using key information based on the obtained information about the imaging operation; and
outputting the encoded radiographic image signal as a radio communication signal.

2. A method of decoding a radiographic image signal comprising:
receiving an input of information about an imaging operation carried out to obtain a radiographic image of a subject;
outputting, to a radiographic image detection device for detecting a radiographic image signal of the subject by receiving radiation transmitted through the subject, the received information about the imaging operation as a radio communication signal;
receiving an encoded radiographic image signal outputted as a radio communication signal from the radiographic image detection device, the encoded radiographic image signal being generated at the radiographic image detection device by encoding the radiographic image signal with using key information based on the information about the imaging operation; and
generating a radiographic image signal by decoding the received encoded radiographic image signal with using key information based on the information about the imaging operation.

3. A radiographic image detection device comprising:
a radiation detecting unit for detecting a radiographic image of a subject by receiving radiation transmitted through the subject;
a reading unit for reading a radiographic image signal representing the radiographic image from the radiation detecting unit;
an imaging information obtaining unit for obtaining information about an imaging operation carried out to obtain the radiographic image of the subject;
an encoding unit for generating an encoded radiographic image signal by encoding the radiographic image with using key information based on the information about the imaging operation obtained by the imaging information obtaining unit; and
a radio communication unit for outputting the encoded radiographic image signal generated by the encoding unit as a radio communication signal.

4. The radiographic image detection device as claimed in claim 3, wherein the information about the imaging operation comprises information that varies for each imaging operation carried out to obtain the radiographic image.

5. The radiographic image detection device as claimed in claim 3, wherein the key information is generated with using a part of the information about the imaging operation.

6. The radiographic image detection device as claimed in claim 3, wherein the information about the imaging operation comprises at least one of an imaging procedure for obtaining the radiographic image, patient information of a patient who is the subject, and an imaging time of the radiographic image.

7. The radiographic image detection device as claimed in claim 3, wherein the information about the imaging operation comprises imaging conditions obtained during the imaging operation carried out to obtain the radiographic image.

8. A radiographic image signal generation device comprising:
an imaging information receiving unit for receiving an input of information about an imaging operation carried out to obtain a radiographic image of a subject;
a radio communication unit for outputting the information about the imaging operation received by the imaging information receiving unit as a radio communication signal to the radiographic image detection device as claimed in claim 3, and for receiving an encoded radiographic image signal generated at the radiographic image detection device with using key information based on the information about the imaging operation and outputted as a radio communication signal; and
a decoding unit for generating a radiographic image signal by decoding the encoded radiographic image signal received by the radio communication unit with using key information based on the information about the imaging operation.

9. The radiographic image signal generation device as claimed in claim 8, wherein the information about the imaging operation comprises information that varies for each imaging operation carried out to obtain the radiographic image.

10. The radiographic image signal generation device as claimed in claim 8, wherein the key information is generated with using a part of the information about the imaging operation.

11. The radiographic image signal generation device as claimed in claim 8, wherein the information about the imaging operation comprises at least one of an imaging procedure for obtaining the radiographic image, patient information of a patient who is the subject, and an imaging time of the radiographic image.

12. The radiographic image signal generation device as claimed in claim 8, wherein the information about the imaging operation comprises imaging conditions obtained during the imaging operation carried out to obtain the radiographic image.
